(19) United States
(12) Patent Application Publication
(10) Pub. No.: US 2017/0029608 A1
(43) Pub. Date: Feb. 2, 2017

(54) Method of Synthesizing Biodegradable Antimicrobial Polymer Containing Low-Density Polyethylene (LDPE), Waste Material of Paper Tissue (WMPT) and Antimicrobial Agents

(71) Applicants: Javad Karimi, Mashhad (IR); Mahsa Naji Khoshnevis, Mashhad (IR)

(72) Inventors: Javad Karimi, Mashhad (IR); Mahsa Naji Khoshnevis, Mashhad (IR)

(21) Appl. No.: 15/295,567

(22) Filed: Oct. 17, 2016

(51) Int. Cl. C08L 23/06

(52) U.S. Cl. CPC C08L 23/06; C08L 2201/06; C08L 2207/066

(57) ABSTRACT

A polymer is synthesized by mixing with an Low-Density Polyethylene (LDPE) a waste material of paper tissue (WMPT), at least one antimicrobial agent, nano cellulose and nano bentonite. Optionally, a nanocomposite suspension is added.

### BACKGROUND

Polyethylene (PE) is used in medical devices and pharmaceutical packaging. Different types of polymers such as high-density PE (HDPE), low-density PE (LDPE), or linear low-density PE (LLDPE) offer different benefits and functionalities. HDPE provides stiffness, chemical resistance, and barrier properties. LDPE offers resistance to stress cracking and excellent impact properties. These parameters are relevant because it is often desired that implants maintain their stability in the body for a predictable time. Such mechanical properties of biomaterial can be important to biocompatibility. For example, an inadequate performance or premature failure of N implants can potentially impose serious health issues to the patients. In addition, body implants can undergo dynamic loading that can affect their mechanical behavior.

### SUMMARY

This Summary identifies example features and aspects that are disclosed, and is not an exclusive or exhaustive description of the disclosed subject matter. Whether features or aspects are included in, or omitted from this Summary is not intended as indicative of relative importance of such features. Additional features and aspects are described, and others will become apparent to persons skilled in the art upon reading the following detailed description and viewing the drawings that form a part thereof.

Examples of disclosed subject matter include a biodegradable anti-microbial polymer containing a mixture of LDEP and waste material of paper tissue (WMPT) in particular relative percentages. Example operations in an implementation of the method can include: synthesis of biodegradable polymer with different percentage of LDEP and WMPT; adding cellulose and bentonite nanoparticles to improve strength and mechanical properties of biodegradable polymer; adding certain amount of antimicrobial agents to the polymer to create antimicrobial property; reporting mechanical, degradation and microbial test results.

### DETAILED DESCRIPTION

In the following detailed description, numerous specific details are set forth by way of examples in order to provide a ready understanding of aspects and various implementations thereof. However, it should be apparent that various aspects can be practiced without such details, well known components, operations and techniques, within combinations and arrangements according to disclosed aspects are described at a relatively high-level, without detail, in order to avoid unnecessarily obscuring aspects.

In an implementation of one example method, a Low-Density Polyethylene (LDPE) is provided, and mixed with the LPDE is an amount of waste material of paper tissue (WMPT) and at least one antimicrobial agent. Features of such a mixture include, but are not limited to, improved mechanical characteristics and improved biodegradability over LPDE alone. Implementations can also include adding, for example, cellulous and bentonite nanoparticles to the LDPE-WMPT polymer. This can provide, for example, certain mechanical properties such as, without limitation, improved Young's modulus, toughness and flexibility. In an aspect, methods can also include adding a nanocomposite suspension to the LPDE with WMPT, examples of which are described in greater later.

Types of low-density polyethylene (LDPE) polymer samples were synthetized in combination with different levels of waste material of paper tissue (WMPT). LDPE and WMPT were weighed by a top loader balance (AND, model GF-3000) with various percentages of LDPE and WMPT as reported in Table 1.

TABLE 1
Relative percentage of LDPE and WMPT of polymer samples.

| Sample ID | % LDPE | % WMPT |
|---|---|---|
| LDPE100-WMPT00 | 100 | 0 |
| LDPE95-WMPT5 | 95 | 5 |
| LDPE85-WMPT15 | 85 | 15 |
| LDPE70-WMPT30 | 70 | 30 |
| LDPE40-WMPT60 | 40 | 60 |

The weighed LDPE and WMPT were premixed and blended in a bra bender mixer for approximately ten minutes at approximately 120° C. A hot press process was applied, followed by a cold press process. The hot press process included preheating, venting, and pressing. The cold press process included a cooling. For both the hot press and cold press, samples were placed in the middle of a square steel frame, which was clipped between two other plates. There were two thinner and smoother steel plates between three layers of thicker plates. The molding temperature and pressure were approximately 150° C. and 10 MPa, respectively. Hot press and cold press processes were applied using the same machine. Hot pressing was conducted at the upper part of the machine, and samples were transferred to the bottom part for cold pressing.

Upon completion of the above-described synthesis process, mechanical and biodegradation tests were performed. The tests included cutting the polymer samples into dumb-bell-shaped pieces by a dumb-bell cutter (model SDL-100; Dumb-Bell Co., Ltd.) according to ASTMD 1882L standard. The dumb-bell-shaped samples had a smooth surface in the neck section, to avoid stress concentration during mechanical test.

In vitro degradation test was performed on the dumb-bell-shaped polymer samples, containing various percentages of WMPT (5%, 15%, 30%, and 60%), by burying the polymer samples at the exterior under the soil at a depth of 2 to 4 feet for a period of one month. The polymer samples included five samples of each of the various percentages of WMPT. Through mass loss and change in surface characterization and morphology, degradation was examined. The polymer samples were weighed to record initial mass, and were then buried. After one month of burial, the samples were dug out and cleaned to ensure complete removal of soil/mud. The samples were placed in an area with sufficient ventilation for natural drying. To identify and measure degradation, the dried samples were weighed using the same electronic balance as carried out before starting degradation.

Tensile testing was applied to verify relation of certain mechanical properties to WMPT content. For the test, dumb-bell-shaped sample thicknesses were measured, using a thickness gauge (Mitutoyo, model EMD-57B-11M). Tensile testing was performed, by applying a uniaxial testing system and a 5 kN load cell according to ASTMD1882L standard. Young's modulus was calculated as stress divided by strain to evaluate the mechanical property of the polymer samples.

Biodegradability and mechanical tests (elongation at break and Young's modulus) were applied to the samples. Results are presented in Table 2 and Table 3, respectively.

TABLE 2
Data from Biodegradability Test

| | | WMPT | Mass before | Mass after | Total Mass |
|---|---|---|---|---|---|
| | | Content | degradation | degradation | Loss |
| LDPE Content (%) | | (%) | (gr) | (gr) | (%) |
| LDPE-WMPT | 100 | 0 | 0.7 | 0.7 | 0 |
| LDPE-WMPT | 95 | 5 | 0.762 | 0.7615 | 0.065 |
| LDPE-WMPT | 85 | 15 | 0.864 | 0.86 | 0.4625 |
| LDPE-WMPT | 70 | 30 | 0.88 | 0.85 | 3.4653 |
| LDPE-WMPT | 40 | 60 | 1 | 0.845 | 15.5 |

Results of the test indicate that incorporation of hydrophilic WMPT into hydrophobic LDPE appears to enhance the hydrophilicity and degradability of the mixed polymer. It appears, without subscribing to any particular scientific theory, that hydrophilic WMPT retains moisture and such moisture contributes to the degradation of the polymer. Accordingly, it appears, without subscribing to any particular scientific theory, that higher level of WMPT in the polymer leads to higher content of moisture, which can cause mixed polymer to degrade faster. Increasing WMPT content resulted in higher surface roughness of the samples in order to increased degradation. The weight loss and change in physical appearance (i.e., surface roughness) of the polymer sample in the soil are evidence of biodegradation of this polymer in the landfills or natural environment.

TABLE 3
Data from Mechanical (elongation at break and Young's modulus) Tests

| | | | | Young |
|---|---|---|---|---|
| | | | Elongation | Modulus |
| Sample ID | LDPE % | WMPT % | (mm) | (MPa) |
| LDPE-WMPT | 100 | 0 | 46.95 | 60.00 |
| LDPE-WMPT | 95 | 5 | 40.05 | 64.76 |
| LDPE-WMPT | 85 | 15 | 25.00 | 78.53 |
| LDPE-WMPT | 70 | 30 | 10.00 | 90.00 |
| LDPE-WMPT | 40 | 60 | 1.53 | 180.00 |

In an aspect, WMPT content and other added materials, described in greater detail later in this disclosure, can provide given mechanical characteristics to the WMPT-incorporated LPDE polymer. For example, tests verified that the elongation at break of the polymer samples decreased with the increase of WMPT content, while Young's modulus increased with the increase of WMPT content as demonstrated in Table 3.

It appears, without subscribing to any particular scientific theory, that a reason can be that WMPT containing hydroxyl groups on its surface is highly hydrophilic, whereas LDPE is nonpolar, and therefore strong interfacial bond (e.g., hydrogen bond) does not form between LDPE and WMPT. Also, without subscribing to any particular scientific theory, it may be that the presence/absorption of moisture by the WMPT at the LDPE-WMPT interface weakens the weak interfacial adhesion. Unlike the elongation, Young's modulus of the synthesized polymer increased with the increase of WMPT content.

It appears, without subscribing to any particular scientific theory, that the increase in modulus of the polymer blend associated with the increase of content may result from the higher stiffness of the WMPT granules. More specifically, it was observed that increasing WMPT content causes the filler-filler interaction to become more sensitive than filler-matrix interaction and, without subscribing to any particular scientific theory, this appears to lead to agglomeration of WMPT granules, which are more rigid or stiffer than the LDPE matrix.

In an aspect, cellulous and bentonite nanoparticles can be added to the LDPE-WMPT polymer, for example, to provide certain mechanical properties such as, without limitation, Young's modulus, toughness and flexibility. Illustration of such mechanical properties is shown by example findings of tests that are summarized here. For the tests, the LDPE-WMPT polymer samples included samples having approximately 50% LDPE and 50% WMPT. Various percentages of cellulous and bentonite nanoparticles (C&B NP) were added to the LDPE-WMPT blends during the blending process. Results are tabulated in Table 4.

TABLE 4
Data from Mechanical Tests on LDPE-WMPT Polymer
Blended with Various Percentages of Cellulous and
Bentonite Nanoparticles.

| | | | | | Young's |
|---|---|---|---|---|---|
| | LDPE | WMPT | C&B | Elongation | Modulus |
| Sample ID | % | % | NP | (mm) | (MPa) |
| LDPE-WMPT | 50 | 50 | 0 | 1.45 | 168.00 |
| LDPE-WMPT-CBNP | 48 | 50 | 2 | 3.56 | 160.32 |
| LDPE-WMPT-CBNP | 46 | 50 | 4 | 7.22 | 150.46 |
| LDPE-WMPT-CBNP | 44 | 50 | 6 | 10.00 | 130.00 |
| LDPE-WMPT-CBNP | 42 | 50 | 8 | 13.03 | 100.25 |
| LDPE-WMPT-CBNP | 40 | 50 | 10 | 15.34 | 78.54 |

As stated above in this disclosure, by increasing WMPT content the filler-filler interaction becomes more sensitive than filler-matrix interaction, which leads to the agglomeration of WMPT granules that are inherently more rigid or stiffer than the LDPE matrix. Therefore it appears, without subscribing to any particular scientific theory, that the increase in modulus of the polymer blend with the increase of content may result from the higher stiffness of the WMPT granules. It was observed that the increase of cellulous and bentonite nanoparticles amount resulted in decrease of Young's modulus and elongation would be increased. As a result, the polymer's mechanical properties were accordingly affected. For example, the elongation became larger, causing a smaller Young's modulus. It is therefore observed that by adding a certain amount of cellulous and bentonite nanoparticles, the mechanical properties can be improved effectively while the polymer kept its biodegradation property. The nanoparticles as softening agents can provide, for example, the polymer being more flexible and can resolve potential toughness effects of WMPT.

To provide antimicrobial property, novel antibacterial, antifungal and antiviral agents can be added to the polymer. The nanocomposite suspension can include nano chitosan, nano cellulose, nano titanium dioxide, nano tin oxide, nano zinc oxide, nano copper oxide, nano bentonite, or a combination thereof, nano chitosan, nanosilver antibacterial ingredient or silver, zinc, copper, or being contained in silver, zinc, copper's antimicrobial master batch, or thermal resisted antibiotics, such as: penicillin, amoxicillin, cephalexin, erythromycin, clarithromycin, biaxin, cipro, Floxin, proloprim, garamycin, tobrex and so on, Or the above mixture of several substances, fungi with antimicrobial activities Colletotrichum sp., Phomopsis isolate, Periconia sp., OBW-15, Guignardia sp. IFBE028, Rhizoctonia sp. Cy064, Aspergillus sp. CY725, Pichia guilliermondii, Xylaria sp. Thielavia subthermophila, Ampelomyces sp., Fusarium sp., Phoma sp., Alternaria sp., Chloridium sp., or a combination thereof, the one or more plants including Cychorium intybus L. (Asteraceae), Salvia officinalis L., Melissa officinalis L., Clinopodium vulgare L. (Lamiaceae), Torilis anthriscus L. (Gmel), Aegopodium podagraria L. (Apiaceae), Cytisus nigricans L., Cytisus capitatus Scop., or a combination thereof

Antimicrobial Test: pieces of standard the polymer containing specific percentage of LDPE, WMPT and an adequate amount of antimicrobial agents (AMA) which are described above were provided (roughly 60% LDPE, 30% WMPT and AMA 10%). Mular Hinton medium was prepared in the form of broth and of agar. McFarland concentration of E. coli and Staphylococcus was inoculated on the medium. Antimicrobial properties of the polymers detected by observing transparent inhibition zone and cell counting.

Examples of preferred concentrations of each group of antibacterial agents in the biodegradable polymer include, an amount of nano chitosan as an antibacterial agent mixed with the polymer being between 0.001% and 5% of a total mass of the polymer, the amount of nano cellulose as a mechanical agent mixed with the polymer being between 0.001% and 5% of a total mass of the polymer, amount of nano titanium dioxide and nano zinc oxide as photocatalytic agents mixed with the polymer being between 0.001% and 2% of a total mass of the polymer, amount of nano tin oxide, nano copper oxide and nano zinc oxide as antimicrobial agents mixed with the polymer being between 0.001% and 4% of a total mass of the polymer, nanocomposite suspension being applied to nanosilver antibacterial ingredient or silver, zinc, copper, or being contained in silver, zinc, copper's antimicrobial master batch, or thermal resisted antibiotics, such as: penicillin, amoxicillin, cephalexin, erythromycin, clarithromycin, biaxin, cipro, Floxin, proloprim, garamycin, tobrex and so on, or the above mixture of several substances, amount of 0.001% to 1% mass fraction of all above material were used in antibacterial polymer, the nanocomposite suspension includes one or more fungi with antimicrobial activities as antibacterial agents, the one or more fungi including Colletotrichum sp., Phomopsis isolate, Periconia sp., OBW-15, Guignardia sp. IFBE028, Rhizoctonia sp. Cy064, Aspergillus sp. CY725, Pichia guilliermondii, Xylaria sp. Thielavia subthermophila, Ampelomyces sp., Fusarium sp., Phoma sp., Alternaria sp., Chloridium sp., or a combination thereof, an amount of the one or more fungi as antibacterial agents mixed with the polymer is between 0.001% and 1% of a total mass of the polymer, the nanocomposite suspension can include one or more plant species with antimicrobial activities as antibacterial agents, the one or more plant species including Cychorium intybus L. (Asteraceae), Salvia officinalis L., Melissa officinalis L., Clinopodium vulgare L. (Lamiaceae), Torilis anthriscus L. (Gmel), Aegopodium podagraria L. (Apiaceae), Cytisus nigricans L., Cytisus capitatus Scop., or a combination thereof, and amount of the one or more fungi as antibacterial agents mixed with the polymer being between 0.001% and 1% of a total mass of the polymer.

What is claimed is:

1. A method for synthesizing polymer, comprising:
providing Low-Density Polyethylene (LDPE);
mixing the LPDE with waste material of paper tissue (WMPT) and at least one antimicrobial agent; and
mixing, as a mechanical agent with the LPDE with WMPT, nano cellulose and nano bentonite,
wherein the mixing the LPDE with WMPT is configured to provide the polymer with LPDE mixed with WMPT in the range of approximately 5% to approximately 60%.

2. The method of claim 1, further comprising:
determining a percentage of WMPT to obtain a desired biodegradability, wherein the determining comprises:
forming dumb-bell shaped polymer samples of the antimicrobial biodegradable polymer, including dumb-bell shaped polymer samples having at WMPT in ranges of approximately 5%, approximately 15%, approximately 30%, and approximately 60%;
burying the polymer samples at the exterior under soil at a given depth for a given period; and
unearthing the polymer samples and performing a biodegradation test.

3. The method of claim 2, wherein the biodegradation test includes determining mass loss and change in surface characterization and morphology.

4. The method of claim 2, wherein the biodegradation test includes:
weighing the polymer samples prior to the burying, the weighing using a given electronic balance;
drying the unearthed polymer samples; and
weighing the dried unearthed polymer samples using said electronic balance.

5. The method of claim 1, wherein an amount of the nano cellulose and nano bentonite as a mechanical agent mixed with the polymer is between 0.001% and 5% of a total mass of the polymer.

6. The method of claim 1, further comprising:
mixing, with the LPDE with WMPT, an antifungal agent, an antiviral agent, or both.

7. The method of claim 1, further comprising:
adding a nanocomposite suspension to the LPDE with WMPT, wherein the nanocomposite suspension includes nano chitosan, nano cellulose, nano titanium dioxide, nano tin oxide, nano zinc oxide, nano copper oxide, nano bentonite, or a combination or sub-combination thereof.

8. The method of claim 7, wherein adding the nanocomposite suspension to the LPDE with WMPT includes injecting the nanocomposite suspension in a dark environment to limited photo catalyst activity.

9. The method of claim 1, further comprising:
adding a nanocomposite suspension to the LPDE with WMPT, wherein the nanocomposite suspension includes nano chitosan, at a percentage within a range extending from about 0.001% to about 5% of a total mass of the polymer.

10. The method of claim 1, further comprising:
adding a nanocomposite suspension to the LPDE with WMPT, wherein the nanocomposite suspension includes nano titanium dioxide and nano zinc oxide as photocatalytic agents, at a percentage within a range extending from about 0.001% to about 2% of a total mass of the polymer.

11. The method of claim 1, further comprising:
adding a nanocomposite suspension to the LPDE with WMPT, wherein the nanocomposite suspension includes nano tin oxide, nano copper oxide and nano zinc oxide as antimicrobial agents, at a percentage within a range extending from about 0.001% to about 4% of a total mass of the polymer.

12. The method of claim 1, further comprising:
adding a nanocomposite suspension to the LPDE with WMPT, wherein the nanocomposite suspension includes nano bentonite as a softening agent, at a percentage within a range extending from about 0.001% to about 5% of a total mass of the polymer.

13. The method of claim 12, wherein the nanocomposite suspension is applied to nanosilver antibacterial ingredient or silver, zinc, copper, or is contained in silver, zinc, copper's antimicrobial master batch, or thermal resisted antibiotics, or a combination or sub-combination therefore at a percentage within a range extending from about 0.001% to 1% mass fraction of all materials in the polymer.

14. The method of claim 1, further comprising:
adding a nanocomposite suspension to the LPDE with WMPT, wherein the nanocomposite suspension includes: one or more fungi, the fungi having antimicrobial activities as antibacterial agents, the one or more fungi including Colletotrichum sp., Phomopsis isolate, Periconia sp., OBW-15, Guignardia sp. IFBE028, Rhizoctonia sp. Cy064, Aspergillus sp. CY725, Pichia guilliermondii, Xylaria sp. Thielavia subthermophila, Ampelomyces sp., Fusarium sp., Phoma sp., Alternaria sp., Chloridium sp., or a combination thereof, and
an amount of the one or more fungi is between 0.001% and 1% of a total mass of the polymer.

15. The method of claim 1, wherein:
adding a nanocomposite suspension to the LPDE with WMPT, wherein the nanocomposite suspension includes one or more plant species with antimicrobial activities as antibacterial agents, the one or more plant species including Cychorium intybus L. (Asteraceae), Salvia officinalis L., Melissa officinalis L., Clinopodium vulgare L. (Lamiaceae), Torilis anthriscus L. (Gmel), Aegopodium podagraria L. (Apiaceae), Cytisus nigricans L., Cytisus capitatus Scop., or a combination thereof, and
an amount of the one or more plant species being between 0.001% and 1% of a total mass of the polymer.
